(19) United States
(12) Patent Application Publication
(10) Pub. No.: US 2005/0026615 A1
(43) Pub. Date: Feb. 3, 2005

(54) System and method for performing a handover in a mobile communication system

(76) Inventor: Young-Hun Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/867,641

(22) Filed: Jun. 16, 2004

(30) Foreign Application Priority Data
Jun. 20, 2003 (KR) 2003-40034

(51) Int. Cl. H04M 11/00; H04Q 7/20

(52) U.S. Cl. 455/436

(57) ABSTRACT

A system and method for performing a handover function in a mobile communication system. The system and method for controlling a User Equipment (UE) to perform a handover from a first Node B to a second Node B in a mobile communication system including a first Radio Network Controller(RNC) for managing the first Node B communicating with the UE and a second RNC for managing the second Node B to which the UE is to be handed over. The system and method comprise transmitting a handover request message including a resource to be assignment-requested to the second RNC over the first RNC; receiving resource information indicative of other assignable resources from the second RNC over the first RNC when the second Node B cannot assign the assignment-requested resource to the UE; and performing the handover using the received resource information.

### PRIORITY

This application claims the benefit under 35 U.S.C. § 119(a) of an application entitled “METHOD FOR PERFORMING HANDOVER IN MOBILE COMMUNICATION SYSTEM”, filed in the Korean Intellectual Property Office on Jun. 20, 2003 and assigned Serial No. 2003-40034, the entire contents of which are incorporated herein by reference.

### BACKGROUND OF THE INVENTION

1. Field of the Invention

The present invention relates to a method for performing a handover in a User Equipment (UE) of a mobile communication system. More particularly, the present invention relates to a system and method for indicating requested radio resources for the handover and unrequested available radio resources.

2. Description of the Related Art

Handover technologies for use in a mobile communication system provide a User Equipment (UE) with continuous service. The UE communicates with other UEs over a network, or gains access to data stored in an external database (DB) server. The mobile UE receiving services from one network may unexpectedly have to change to another network. For example, the mobile UE may leave the coverage area of the first network and enter the coverage area of a second network. In this case, the UE requires the same service from the second network, and requires such handover technologies to provide continuous service to the UE in the second network.

The handover function is classified into a soft handover function and a hard handover function. The soft handover function refers to a communication initiation method for starting communication with a new Node B before blocking communication with an old Node B. The soft handover function is established between Code Division Multiple Access (CDMA) channels on the same frequency channel, and provides a downlink traffic channel path and an uplink channel path with diversity at a boundary between two Node Bs. The hard handover function is performed when a channel assigned to the UE and the other channel to be assigned based on movement between cells of the two networks have different frequencies or different frame offsets. When performing the hard handover function, continuity of a radio link is not maintained but rather is instantaneously blocked.

Such a handover function may be requested while the UE is in motion, or the network for controlling the UE may have the UE perform the handover. If the UE requests the handover, the network assigns new radio resources to the UE, and has the UE use the assigned radio resources. If the network has the UE perform the handover function, it controls the UE to use other radio resources according to an operation command of the network.

FIG. 1 is a block diagram illustrating a conventional mobile communication system. The conventional mobile communication system and its detailed components will hereinafter be described with reference to FIG. 1.

The mobile communication system includes Core Networks (CNs) 100 and 102, Radio Network Controllers (RNCs) 110, 112, 114, and 116, Node Bs 120, 122, and 124, and a User Equipment (UE) 130. The UE 130 is connected to the Node B 122, and the Node B 122 is connected to the RNC 112. The RNC 112 is connected to the CN 100. If the UE 130 wishes to access data stored in an external DB server or the another UE, it uses the Node B 122 and the RNC 112. The Node Bs 120-124 and the RNCs 110-116 are called a Radio Network Subsystem (RNS).

Although it is not shown, each of the RNCs 110-116 are typically connected to a plurality of Node Bs 120-124 even though FIG. 1 depicts only the RNC 112 as being connected to a plurality of Node Bs. The RNCs 110-116 manages radio resources of the Node Bs 120-124. The RNCs 110-116 are connected to one or more CNs 110-102. The Node Bs 120-124 manage UEs 130 positioned in a specific cell area, and transmit data transferred to the RNCs 110- 116 to the UE 130. The Node B 122 transmits the data transferred from the UE 130 to the RNC 112 over a communication network. The UE 130 may move from the Node B 122 managed by a specific RNC 112 to the Node B 124 managed by the other RNC 114. The UE 130 may also move to another Node B 120 managed by the RNC 112 which also manages the Node B 122. If the UE 130 moves from one position to another position within the range of the Node Bs 120-122, the RNC 112 is aware of the radio resource information of its associated Node Bs 120-122. Therefore, the handover function performed by a plurality of Node Bs managed by the same RNC uses pre-recognized radio resource information.

However, if the handover function is performed from a Node B managed by a specific RNC to another Node B managed by another RNC, the specific RNC cannot recognize the radio resource information of the Node B managed by the other RNC. Specifically, the RNC 112 cannot recognize usage state information of the radio resources of the Node B 124. The handover function performed between other RNCs will hereinafter be described with reference to FIG. 2.

FIG. 2 is a flow chart illustrating a handover process performed between different RNCs. The handover process performed between different RNCs will hereinafter be described with reference to FIG. 2.

FIG. 2 depicts a UE 200 for performing a handover from a first Node B to a second Node B, a first RNC 202 for managing the first Node B, and a second RNC 204 for managing the second Node B. Although FIG. 2 can depict other mobile communication systems instead of the aforementioned components, it should be noted that other systems necessary for describing the handover process have been omitted for convenience. The first RNC 202 manages a plurality of Node Bs other than the first Node B connected to the UE 200. The second RNC 204 manages a plurality of Node Bs other than the second Node B that is a handover target of the UE 200.

As stated above, the first RNC 202 and its associated Node Bs are called a first Radio Network Subsystem (RNS), and the second RNC 204 and its associated Node Bs are called a second RNS.

The UE 200 communicating with the first Node B managed by the first RNC 202 is handed over to the second Node B. In FIG. 2, it should be noted that the second Node B to which the UE 200 is to be handed over is managed by the second RNC 204. The UE 200 transmits a handover request message to the first RNC 202 at step 210. In order to request a handover to the second Node B managed by the second RNC 204, the UE 200 transmits the handover request message to the first RNC 202 over the first Node B.

The first RNC 202 transmits a handover request message for determining whether the handover function is available or unavailable to the second RNC 204 at step 212. In this case, the second RNC 204 determines whether the second Node B can assign radio resources requested by the UE 200, such that it can determine whether the handover function is available. Specifically, the UE 200 pre-determines (prior to actually assigning the specific radio resources) specific radio resources it needs to be assigned by the second Node B. Therefore, the first RNC 202 queries the second RNC 204 as to whether the second Node B can assign the specific radio resources.

The second RNC 204 determines whether the second Node B can assign the specific radio resources to the UE 200. The second RNC 204 updates and stores radio resources associated with the second Node B at intervals of a predetermined time, and determines an assignable or un-assignable state of the requested radio resources using the stored update information. If the first RNC 202 queries the second RNC 204 as to whether the second Node B can assign the requested radio resources, the second RNC 204 determines whether the second Node B can assign the requested radio resources. As can be seen from FIG. 2, the second Node B cannot assign the requested radio resources.

The second RNC 204 transmits a response message associated with the assignable or un-assignable state of the radio resources to the first RNC 202 at step 214. In this case, the response message of the second 204 RNC indicates that the second Node B cannot support the radio resources in association with the configurations of FIG. 2.

Upon receiving the response message indicative of the un-assignable state of the radio resources from the second RNC 204, the first RNC 202 transmits a response message indicative of a handover failure state to the UE 200 at step 216. Specifically, the first RNC 202 provides a message to the UE 200 indicating that the second Node B cannot assign the radio resources requested by the UE 200. If the UE 200 receives the message indicative of the un-assignable state of the radio resources, a call-connection mode indicative of a data communication state is blocked.

As described in FIG. 2, the second RNC can determine only an assignable or un-assignable state of the specific radio resources requested by the first RNC, and cannot determine an assignable or un-assignable state of radio resources not requested by the first RNC. In conclusion, due to the aforementioned problems, an improved method for adapting the radio resources not requested by the first RNC must be developed to perform an effective handover operation.

### SUMMARY OF THE INVENTION

Therefore, the present invention has been made in view of the above problems, and it is an object of the present invention to provide a system and method for controlling a Radio Network Controllers (RNC) to effectively manage assignable radio resources of Node Bs managed by the RNC, and performing a handover function using the radio resources.

It is another object of the present invention to provide a system and method for performing a handover function using other assignable radio resources when a second Node B cannot assign radio resources requested by a user equipment (UE).

It is yet another object of the present invention to provide a system and method for indicating other assignable radio resources when the second Node B cannot assign radio resources requested for a handover, and performing a handover function using radio resources similar to the requested radio resources from among the indicated radio resources.

In accordance with one aspect of the present invention, the above and other objects can be accomplished by the provision of a system and method for controlling a User Equipment (UE) to perform a handover from a first Node B to a second Node B in a mobile communication system comprising a first Radio Network Controller (RNC) for managing the first Node B communicating with the UE and a second RNC for managing the second Node B to which the UE is to be handed over. The system and method comprise transmitting a handover request message including resources which the UE has requested to the second RNC via the first RNC; receiving information indicative of other assignable resources from the second RNC via the first RNC and reporting the received resource information if the second Node B is unable to assign the resources which the UE has requested to the UE; and performing the handover using the received resource information.

In accordance with another aspect of the present invention, a system and method for performing a handover using a second Radio Network Controller (RNC) in a mobile communication system comprising a first RNC for managing a first Node B communicating with a User Equipment (UE) and a second RNC for managing a second Node B to which the UE is to be handed over are provided. The system and method comprise receiving a handover request message including resources which the UE has requested via the first RNC; determining whether the second Node B can assign the requested resources; searching for other assignable resources in the second Node B if the second Node B cannot assign the requested resources according to the result of the determination; transmitting a message including information on the searched resource to the first RNC if a single assignable resource is found in the second Node B; transmitting a handover command message including the searched resource to the UE via the first RNC if the information includes a single searched resource; and receiving a successful handover message from the UE via the first RNC.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a conventional mobile communication system;

FIG. 2 is a flow chart illustrating a handover process performed in response to a handover request signal by a User Equipment (UE) in a mobile communication system;

FIG. 3 is a diagram illustrating a handover process for a mobile communication system in accordance with an embodiment of the present invention;

FIG. 4 is a flow chart illustrating a handover process in accordance with an embodiment of the present invention;

FIG. 5 is a flow chart illustrating a handover process in accordance with another embodiment of the present invention;

FIG. 6 is a flow chart illustrating operations of an RNC in accordance with still another embodiment of the present invention; and

FIG. 7 is a flow chart illustrating operations of a UE in accordance with the yet another embodiment of the present invention.

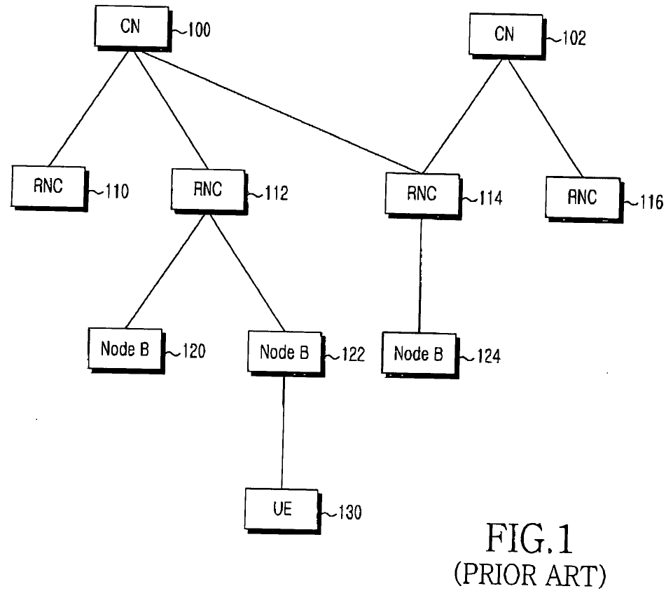

Throughout the drawings, it should be noted that the same or similar elements are denoted by like reference numerals.

### DETAILED DESCRIPTION OF THE PREFERRED EMBODIMENTS

Various embodiments of the present invention will now be described in detail with reference to the accompanying drawings. In the following description, a detailed description of known functions and configurations incorporated herein will be omitted for conciseness.

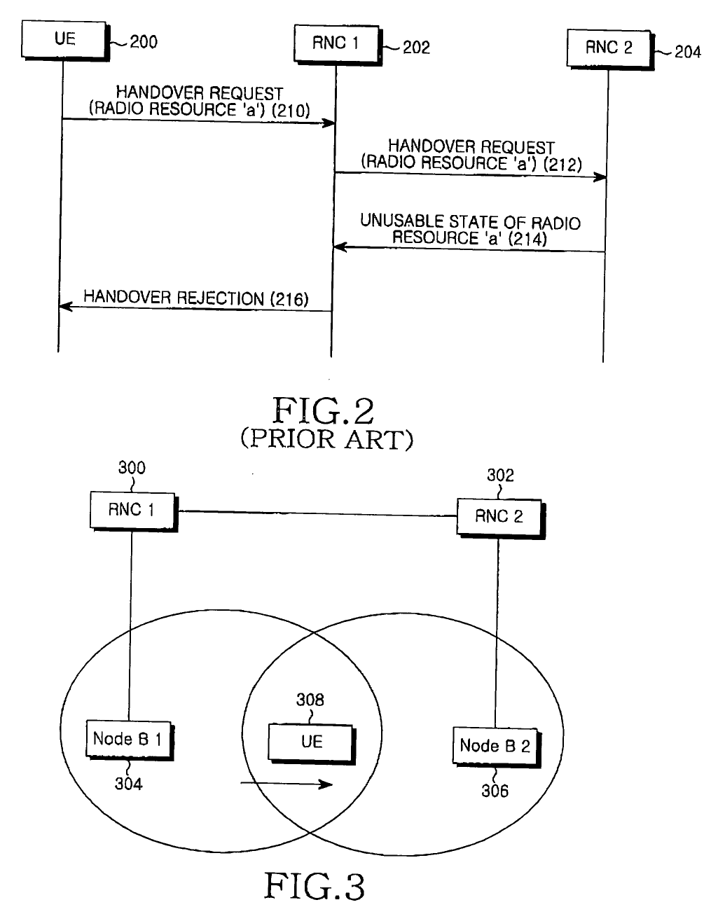

FIG. 3 is a diagram illustrating a handover process in which a User Equipment (UE) 308 moves from a first Node B 304 managed by a first RNC 300 to a second Node B 306 managed by a second RNC 302. The handover process for controlling the UE 308 to be handed over to the second Node B 306 managed by the second RNC 302 will hereinafter be described with reference to FIG 3.

FIG. 3 shows a mobile communication system comprising a first RNC 300, the first Node B 304 managed by the first RNC 300, a second RNC 302, the second Node B 306 managed by the second RNC 302, and the UE 308. Although other systems not shown in FIG. 3 can also be included in the mobile communication system if needed, the following description will herein be limited to exemplary systems for the convenience of description.

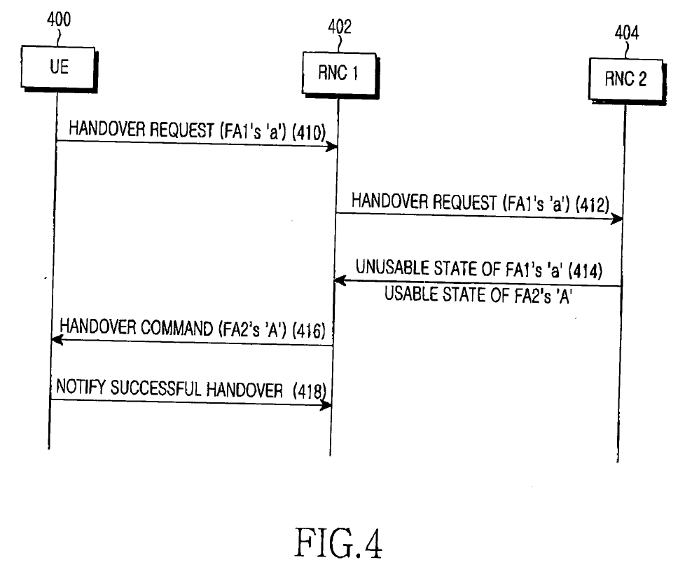

The UE 308 originates in a cell area supported by the first Node B, such that it can transmit and receive data to and from the first Node B 304. The UE 308 moves from the cell area supported by the first Node B 304 to another cell area supported by the second Node B 306. The UE 308 compares a reception intensity of a pilot channel signal received from the first Node B 304 with that of another pilot channel signal received from the second Node B 306. If periodic or specific event information occurs according to a report method selected by the first RNC 300, the UE 308 transmits information indicative of the occurrence of the period or specific event information to the first Node B 304. In this case, the event information may indicate that individual reception intensities of pilot channel signals received from the first and second Node Bs 304 and 306 are higher or lower than a specific value selected by the first RNC 300, or may also indicate that a difference between reception intensities of pilot channel signals received from the first and second Node Bs 304 and 306 is higher or lower than a specific value selected by the first RNC 300. The specific value is determined by the first RNC 300. The first Node B 304 receiving pilot channel information from the UE 308 transmits the received information to the first RNC 300. The first RNC 300 transmits a handover request to the second RNC 302. The second RNC 302 having received the handover request generates an approval or disapproval message in response to the handover request. The first RNC 300 having received the approval or disapproval message of the requested handover transmits a response message indicative of a handover possibility or impossibility to the UE 304. If it is determined that the handover is possible, the UE 308 is handed over from the first Node B 304 to the second Node B 306, and a detailed description of this process will hereinafter be described with reference to FIG. 4.

FIG. 4 is a flow chart illustrating a handover process in which the UE is handed over between different RNCs in accordance with an embodiment of the present invention. The handover process will hereinafter be described with reference to FIG. 4.

FIG. 4 depicts a UE 400 for performing a handover from a first Node B (Not shown) to a second Node B (Not shown), a first RNC 402, and a second RNC 404. In more detail, the first Node B is managed by the first RNC 402, and the second Node B is managed by the second RNC 404. The first RNC 402 and the second RNC 404 are connected to each other over a Radio Network Subsystem Application Protocol (RNSAP). The first RNC 402 transmits a variety of information to the second RNC 404 over the RNSAP, for example, service category (such as packet data or voice data), cell ID, code, and reception power information of the UE 400, and so on.

If the UE 400 moves from a cell area managed by the first Node B to a cell area managed by the second Node B, the UE 400 transmits a handover request message to the first RNC 402 at step 410. In this case, the handover request message includes a request to assign a radio resource which the UE 400 will use in the second Node B after it is handed over from the first Node B to the second Node B. The radio resource requested by the UE 400 may be a radio resource which are assigned from the first Node B to the UE 400 and are then used by the UE 400, or may be indicative of newly-requested radio resource having a frequency different from that of the radio resource currently used by the UE 400.

The first RNC 402 having received the handover request message from the UE 400 at step 410 transmits a handover request message to the second RNC 404 at step 412. The first RNC 402 is incapable of indicating whether the second Node B can assign the radio resource requested by the UE 400. The handover request message indicates a request for determining whether the second Node B can assign the radio resource requested by the UE 400.

The second RNC 404 having received the handover request message from the first RNC 402 determines whether the second Node B can assign the radio resource. If it is determined that the second Node B can assign the radio resource, the second RNC 404 generates a response message to the handover request message. However, there may arise an unexpected case in which the second Node B is unable to assign the radio resource requested by the UE 400.

For example, each Node B can support a maximum of 4 Frequency Assignment (FA)-6 sector information, but it can generally support 2FA-3 sector information. The RNCs monitor radio resources which can be assigned by Node Bs managed by the RNCs at intervals of a predetermined time, and store the monitored information. Otherwise, upon receipt of a request to be handed over to a specific Node B, a corresponding RNC checks information indicative of the assignable radio resources from the specific Node B.

A representative example for controlling the second RNC 404 to store the radio resource information of the second Node B at intervals of a predetermined time is shown in the following Table 1:

TABLE 1

| # of Assignable | | |
|---|---|---|
| Resources | FDA1 | FA2 |
| 1 | a | A |
| 2 | b, c | B |
| 3 | d, e, f | C, D |
| 4 | g, h, l, j | E, D, G |

Table 1 depicts the second Node B's assignable radio resources stored in the second RNC 404. The second RNC 404 stores all the information recorded in Table 1 in association with all the Node Bs managed by the second RNC 404. The second Node B uses two FAs, each of which varies the number of supportable radio resources according to a supported transfer rate. Typically, if a mobile communication system for use in a frequency bandwidth of 5 MHz transmits packet data at 384 kbps, four radio resources may be assigned to one FA included in a single cell. However, in the case of transmitting voice data at 12.2 kbps, 196 radio resources are assigned to only one FA included in the single cell. For convenience, the number of assignable radio resources and the number of categories of the assigned radio resources shown in Table 1 are limited. The number of categories of the assigned radio resources (i.e., the number of assignable radio resources) is determined to be 4, as shown in Table 1.

If the first RNC 402 requests the assignment of FA1's ‘a’ from the second Node B in order to perform the handover function, the second RNC 404 determines whether the second Node B can assign the FA1's ‘a’. In FIG. 4, it is assumed that the second Node B has assigned the FA1's ‘a’ to another UE.

The second RNC 404 transmits a response message to the first RNC 402 at step 414. In this case, by means of the response message, the second RNC 404 notifies the first RNC 402 that the second Node B is unable to assign the FA1's ‘a’ indicative of radio resource requested for a handover, and is able to assign FA2's ‘A’ substituting for the FA1's ‘a’. Conventionally, the second RNC 404 determines an assignable or un-assignable state in association with only the requested radio resource, and transmits the determined result to the first RNC 402 as the response message. However, in an embodiment of the present invention a determination is made as to whether the second Node B can assign the requested radio resource. If it is determined that the second Node B can assign the requested radio resource, the second RNC 404 searches for other assignable radio resource, and transmits the searched radio resource using a response message.

The first RNC 402 transmits a control command to the UE 400 such that the UE 400 performs a handover from the first Node B to the second Node B using the FA2's ‘A’ at step 416. Although the UE 400 has requested a handover to the FA1's ‘a’, it performs a handover to the FA2's ‘A’ instead of the FA1's ‘a’ indicative of the requested radio resource. The UE 400 performs a handover operation using the FA2's ‘A’ at step 418.

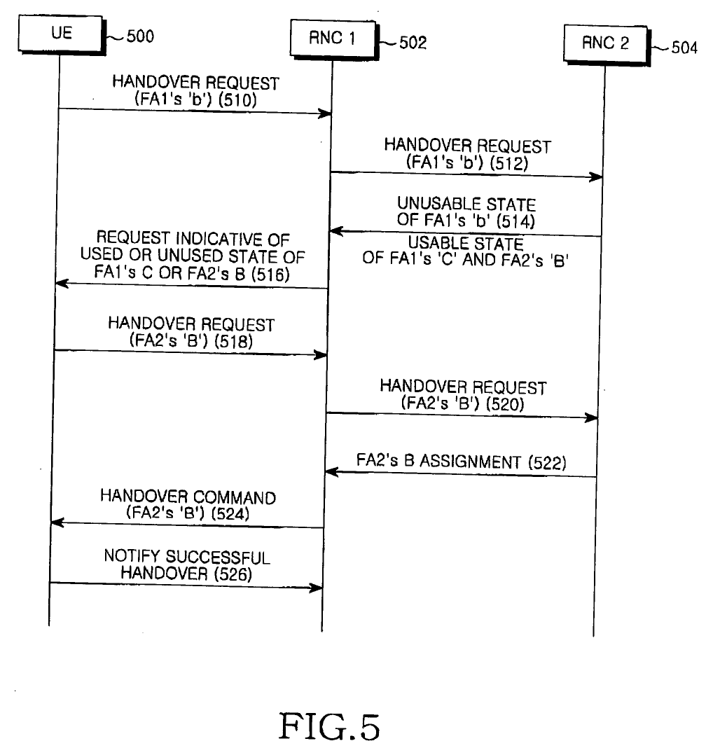

FIG. 5 is a flow chart illustrating a handover process in which the UE is handed over between different RNCs in accordance with another embodiment of the present invention. The UE's handover process will hereinafter be described with reference to FIG. 5.

If the UE 500 moves from a cell area managed by a first Node B (Not shown) to a cell area managed by a second Node B (Not shown), the UE 500 transmits a handover request message to a first RNC 502 over the first Node B at step 510. In this case, the handover request message includes a request to assign specific radio resource which the UE 500 will use in the second Node B after it is handed over from the first Node B to the second Node B.

The first RNC 502 having received the handover request message from the UE 500 transmits a handover request message to the second RNC 504 at step 512. The first RNC 502 is incapable of determining whether the second Node B can assign the radio resource requested by the UE 500. The handover request message indicates a request for determining whether the second Node B can assign the radio resource requested by the UE 500.

The second RNC 504 having received the handover request message from the first RNC 502 determines whether the second Node B can assign the radio resource. If it is determined that the second Node B can assign the radio resource, the second RNC 504 generates a response message corresponding to the handover request message. However, there may arise an unexpected case in which the second Node B is unable to assign the radio resource requested by the first RNC 502. Specifically, there may arise a specific case in which the second Node B has already assigned the radio resource to other UEs.

As described, the RNCs monitor radio resources which can be assigned by Node Bs managed by the RNCs at intervals of a predetermined time, and store the monitoring information. Otherwise, upon receipt of the request to be handover over to a specific Node B, the RNCs receive information indicative of the assignable radio resources from the specific Node B. A representative example in which the RNCs store the radio resource information of the specific Node B at intervals of a predetermined time is shown in Table 1.

If the first RNC 502 requests the FA1's ‘b’ from the second Node B to perform the handover function, the second RNC 504 determines whether the second Node B can assign the FA1's ‘b’. In FIG. 5, it is assumed that the second Node B has assigned the FA1's ‘b’ to another UE. The second RNC 504 transmits a response message to the first RNC 502 at step 514. In this case, by means of the response message, the second RNC 504 notifies the first RNC 502 that the second Node B is unable to assign the FA1's ‘b’ indicative of radio resources requested for a handover, and is able to assign FA1's ‘c’ and FA2's ‘B’ each substituting for the FA1's ‘b’. Conventionally, the second RNC 504 determines an assignable or un-assignable state in association with only the requested radio resource, and transmits the determined result to the first RNC 502 as a response message. However, in an embodiment of the present invention a determination is made as to whether the second Node B can assign the requested radio resource. If it is determined that the second Node B can assign the requested radio resource, searches are performed in an embodiment of the present invention for other assignable radio resources, and reports the searched radio resources using a response message.

The first RNC 502 informs the UE 500 of the response message indicating that the second Node B can assign the FA1's ‘c’ and FA2's ‘B’ indicative of the reported radio resources at step 516. Although the UE 500 has requested a handover to the FA1's ‘b’, it performs a handover using other radio resources instead of using the requested radio resource. The UE 500 selects one of the reported radio resources (such as the FA1's ‘c’ and the FA2's ‘B’). In this case, the method for selecting one of the reported radio resources can be freely determined by a user. Specifically, the user may first select the same FA, or may select radio resources similar to the pre-assigned radio resources. If it is determined that a frequency of the radio resource for use in the first Node B is different from that of the reported radio resources, the UE 500 searches for the reported radio resources using a compressed mode.

The UE 500 transmits a handover request message associated with the searched radio resources to the first RNC 502 at step 518. It is assumed that the UE 500 requests radio resources associated with the FA2's ‘B’ in FIG. 5, but it should be noted that the UE 500 can also request radio resources associated with the FA1's ‘c’ having the same frequency as in the FA2's ‘B’.

The first RNC 502 transmits a request message to the second RNC 504 at step 520, such that the second Node B can assign the FA2's ‘B’ indicative of radio resource requested by the UE 500. The second RNC 504 transmits the assigned FA2's ‘B’ to the first RNC 502 at step 522. The first RNC 502 transmits a control command to the UE 500 at step 524, such that the UE 500 can perform the handover function using the assigned FA2's ‘B’. The UE 500 performs the handover function using the FA2's ‘B’. The UE 500 performs the handover function using the FA2's ‘B’, and transmits a message indicative of a successful handover to the first RNC 502 at step 526.

In FIGS. 4 and 5, it is assumed that the second RNC notifies the first RNC of only radio resources capable of supporting the same Quality of Service (QoS) as that of the radio resource requested by the UE for the convenience of explanation. However, if radio resources having the same QoS as the radio resource requested by the UE are not found, in an embodiment the present invention can also notify the first RNC of radio resources having a QoS similar to that of the requested radio resource.

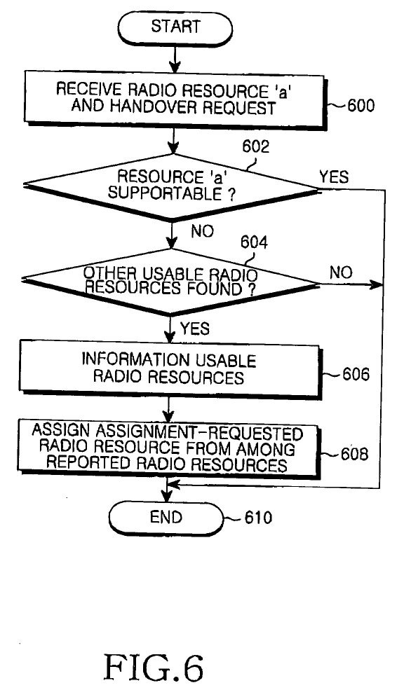

FIG. 6 is a flow chart illustrating operations of the second RNC of FIGS. 4 and 5 in accordance with another embodiment of the present invention. The second RNC receives a handover request message including the radio resource ‘a’ from the first RNC at step 600. The second RNC having received the handover request message including the radio resource ‘a’ determines whether the second Node B can assign the requested radio resource ‘a’ at step 602. If it is determined that the second Node B can assign the requested radio resource ‘a’ at step 602, the second RNC transmits a message indicative of the assignment enable state of the requested radio resource ‘a’ to the first RNC, and goes to step 610 where the method terminates. Otherwise, if it is determined that the second Node B cannot assign the requested radio resource ‘a’ at step 602, the second RNC goes to step 604.

The second RNC determines whether other assignable radio resources instead of the requested radio resource ‘a’ are found at step 604. If it is determined that the other assignable radio resources are not found at step 604, the second RNC notifies the first RNC of a response message indicating that the second Node B cannot assign the radio resource ‘a’, and goes to step 610. Otherwise, if it is determined that other assignable radio resources are found at step 604, the second RNC goes to step 606.

The second RNC notifies the first RNC of other assignable radio resources found during the step 604, instead of the requested radio resource ‘a’, at step 606. The searched assignable radio resources may have the same frequency as the requested radio resource ‘a’, or may have a frequency different from the frequency of the requested radio resource ‘a’. Also, the found assignable radio resources may be indicative of radio resources having similar QoSs instead of the same QoS, and the second RNC may notify the first RNC of one or more radio resources.

The second RNC receives an assignment-request for a selected radio resource among the notified radio resources from the first RNC and controls the second Node B to assign the selected radio resource at step 608, and goes to step 610.

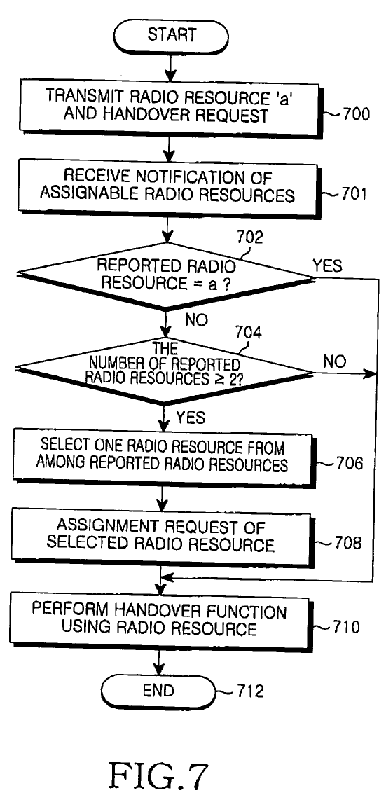

FIG. 7 is a flow chart illustrating operations of the UE for performing a handover from a first RNC to a second RNC in accordance with yet another embodiment of the present invention. The UE transmits the handover request message indicating an assignment-request for a radio resource ‘A’ to the second RNC via the first RNC at step 700. The second RNC reports information of assignable radio resources to the UE via the first RNC at step 701, so that the UE can recognize the reported assignable radio resources. The UE determines whether the reported radio resources include the requested radio resource at step 702. In this case, if it is determined that the reported radio resources include the requested radio resource at step 702, the UE goes to step 710. Otherwise, if it is determined that the reported radio resources do not include the requested radio resource at step 702, the UE goes to step 704.

The UE determines whether the number of reported radio resources is greater than or equal to ‘2’ at step 704. If it is determined that the number of received radio resources is greater than or equal to ‘2’ at step 704, the UE goes to step 706. Otherwise, if it is determined that the number of reported radio resources is less than ‘2’ at step 704, the UE goes to step 710. The UE selects the single reported radio resource at step 706.

The UE transmits a request to assign the selected radio resource to the second RNC via the first RNC at step 708. The second RNC informs the UE that the selected radio resource is approved, and then the UE performs a handover using the approved radio resource at step 710. If the reported radio resources include the requested radio resource at step 702, the UE performs the handover function using the requested radio resource at step 710, and terminates the handover process at step 712.

As apparent from the above description, embodiments of the present invention can effectively use radio resources compared to the prior art which is unable to perform a handover even though there are available radio resources other than handover-requested radio resource. In other words, embodiments of the present invention performs the handover using other available radio resources other than the requested radio resource, resulting in effective management of radio resources.

Although certain embodiments of the present invention have been disclosed for illustrative purposes, those skilled in the art will appreciate that various modifications, additions and substitutions are possible, without departing from the scope and spirit of the invention as disclosed in the accompanying claims.

1. A method for performing a handover from a first Node B to a second Node B in a mobile communication system comprising a first Radio Network Controller (RNC) for managing the first Node B communicating with a User Equipment (UE) and a second RNC for managing the second Node B to which the UE is to be handed over to, comprising the steps of:
transmitting a handover request message comprising a resource to be assignment-requested to the second RNC via the first RNC;
receiving resource information indicative of other assignable resources from the second RNC over the first RNC when the second Node B is full of the assignment-requested resource to the UE; and
performing the handover using the received resource information.

2. The method according to claim 1, wherein the performing step further comprising:
selecting a single resource from among the assignable resources according to a predetermined sequence if the number of the assignable resources is greater than ‘2’; and
performing the handover using the selected resource.

3. The method according to claim 2, wherein the selecting step further comprises:
selecting a resource having the same frequency as the assignable resources.

4. The method according to claim 2, wherein the performing step further comprises the step of:
transmitting a handover request message for requesting to assign the selected resource to the second RNC via the first RNC.

5. The method according to claim 1, wherein the handover request message comprises a service category, a cell Identifier (ID), a code, and a reception power information of the UE.

6. A method for performing a handover using a second Radio Network Controller (RNC) in a mobile communication system comprising a first RNC for managing a first Node B communicating with a User Equipment (UE) and a second RNC for managing a second Node B to which the UE is to be handed over, comprising the steps of:
receiving a handover request message comprising resource which the UE has requested via the first RNC;
determining whether the second Node B can assign the requested resource;
searching for other assignable resources in the second Node B when the second Node B is full of the requested resource transmitting a message comprising resource information of the assignable resources to the first RNC if assignable resources are searched; and
performing a handover using the resource information.

7. The method according to claim 6, wherein the performing step further comprises:
transmitting a message indicative of a used or unused state of the assignable resources to the UE from the first RNC if the resource information includes two or more assignable resources;
receiving a handover request message including a resource selected from among the assignable resources to the first RNC from the UE; and
performing the handover using the selected resource.

8. The method according to claim 6, wherein the performing step further comprises:
transmitting a handover command message including the single resource to the UE from the first RNC if the information includes a single resource; and
receiving a successful handover message to the first RNC from the UE.

9. The method according to claim 6, wherein the handover request message includes service category, cell Identifier (ID), code, and reception power information of the UE.

10. A communication system for performing a handover from a first Node B to a second Node B, comprising:
a first Radio Network Controller (RNC) adapted to manage the first Node B in communication with a User Equipment (UE) and
a second RNC adapted to manage the second Node B to which the UE is to be handed over to; and
the UE adapted to transmit a handover request message comprising a resource to be assignment-requested to the second RNC via the first RNC, receive resource information indicative of other assignable resources from the second RNC via the first RNC when the second Node B is full of the assignment-requested resource to the UE, and perform the handover using the received resource information.

11. The system according to claim 10, wherein the UE is further adapted to select a single resource from among the assignable resources according to a predetermined sequence if the number of the assignable resources is greater than ‘2’, and perform the handover using the selected resource.

12. The system according to claim 11, wherein the UE is further adapted to select a resource having the same frequency as the assignable resources.

13. The system according to claim 11, wherein the UE is further adapted to transmit a handover request message for requesting to assign the selected resource to the second RNC via the first RNC.

14. The system according to claim 10, wherein the handover request message includes service category, cell Identifier (ID), code, and reception power information of the UE.

15. A communication system for performing a handover from a first Node B to a second Node B, comprising:
a first Radio Network Controller (RNC) adapted to manage the first Node B in communication with a User Equipment (UE); and
a second RNC adapted to manage the second Node B to which the UE is to be handed over to, determine whether the second Node B can assign the requested resource, search for other assignable resources in the second Node B when the second Node B is full of the assignment requested resource, transmit a message comprising resource information of the assignable resources to the first RNC if assignable resources are searched, and perform a handover using the resource information.

16. The system according to claim 15, wherein the first RNC is further adapted to transmit a message indicative of a used or unused state of the assignable resources to the UE if the resource information includes two or more assignable resources, receive a handover request message including a resource selected from among the assignable resources from the UE, and perform the handover using the selected resource.

17. The system according to claim 15, wherein the first RNC is further adapted to transmit a handover command message comprising the single resource to the UE if the information comprises a single resource, and receive a successful handover message from the UE.

18. The system according to claim 15, wherein the handover request message comprises a service category, a cell Identifier (ID), a code, and a reception power information of the UE.
